(19) United States
(12) Patent Application Publication
(10) Pub. No.: US 2011/0059739 A1
(43) Pub. Date: Mar. 10, 2011

(54) Method of Radio Access Technology Selection and Related Communication Device

(76) Inventor: Chien-Jen Huang, Taoyuan County (TW)

(21) Appl. No.: 12/877,080

(22) Filed: Sep. 7, 2010

Related U.S. Application Data
(60) Provisional application No. 61/240,660, filed on Sep. 9, 2009.

(51) Int. Cl. H04W 4/00

(52) U.S. Cl. 455/435.1

(57) ABSTRACT

A method of radio access technology (RAT) selection for a mobile device in a wireless communication system includes selecting a first RAT to use when powering on, wherein the first RAT is capable of providing services of a first service domain, handing over to a second RAT capable of providing services of a second service domain when the mobile device needs to perform a first service on the second service domain, and returning to the first RAT while the mobile device needs to perform a second service on the first service domain.

### CROSS REFERENCE TO RELATED APPLICATIONS

This application claims the benefit of U.S. Provisional Application No. 61/240,660, filed on Sep. 09, 2009 and entitled “Radio access technology selection in LTE with CS fallback voice solution” the contents of which are incorporated herein.

### BACKGROUND OF THE INVENTION

1. Field of the Invention

The present invention relates to a method used in a wireless communications system and related communication device, and more particularly, to a method for radio access technology selection in a wireless communications system and related communication device.

2. Description of the Prior Art

In a wireless telecommunication system, a mobile device can be pre-set to select a preferred system to use (e.g. select a cell of the preferred system to camp on) each time when the mobile device powers on.

The mobile device may include a long-term evolution (LTE) preferred mode and a legacy preferred mode. When the mobile device of the LTE preferred mode powers on, the mobile device prefers to camp on a cell of a LTE system (i.e. a LTE cell) rather than cells of other radio access technologies (RATs), e.g. a universal mobile telecommunications system (UMTS), a global system for mobile communications (GSM) or a code division multiple access 2000 (CDMA2000). On the contrary, when the mobile device of the legacy preferred mode powers on, the mobile device prefers to camp on a 3G/2G (e.g. UMTS/GSM) cell rather than the cells of other RATs, e.g. LTE or CDMA2000.

The LTE system, initiated by the third generation partnership project (3GPP), supports packet switched (PS) services and does not support circuit switched (CS) services. On the other hand, the UMTS system and GSM system with general packet radio service (GPRS) supports both of the PS and CS services.

Suppose that the mobile device is in the LTE preferred mode and thereby initially camps on the LTE network after power-up. If a mobile terminated (MT) or a mobile originated (MO) voice call that is a CS service is triggered, the mobile device performs a CS fallback procedure to make a voice call in the UMTS/GSM network. Since the LTE does not support CS services, the CS fallback procedure allows the mobile device to hand over to a system supporting CS services and reuse CS infrastructure of the system. After the mobile device completes the MT/MO voice call, the mobile device will move back to the LTE network, by which the mobile device will initiate the CS fallback procedure again when the next MO or MT voice call is triggered. Generally, the CS fallback procedure take a few seconds to execute and therefore does not provide user experiences as good as a call setup procedure of the UMTS/GSM network due to the longer call setup delay and higher rate of call setup failures.

In addition, when the mobile device is in legacy preferred mode, the mobile device initially camps on the UTRAN/GERAN network after power-up. If a data service that is a PS service is initiated, the UE may move to the LTE network to start a data session. After the mobile device or the network terminates the data session, the mobile device will move back to the UMTS/GSM network, by which the mobile device will move to the LTE network again when the next data service is initiated. Moving to the LTE network from UMTS/GSM network to initiate the data session degrades the user experience due to the delays experienced while transitioning to LTE and the difficulty in determining if LTE is available.

### SUMMARY OF THE INVENTION

The disclosure therefore provides a method and related communication device for selecting radio access technology (RAT) in order to avoid a long delay in call making.

A method of RAT selection for a mobile device in a wireless communication system is disclosed. The method includes selecting a first RAT to use when powering on, wherein the first RAT is capable of providing services of a first service domain, handing over to a second RAT capable of providing services of a second service domain when the mobile device needs to perform a first service on the second service domain, and returning to the first RAT while the mobile device needs to perform a second service on the first service domain.

A method of RAT selection for a mobile device in a wireless communication system is disclosed. The method includes storing RAT selecting information corresponding to a first RAT, wherein the first RAT is used by the mobile device upon the powering-off, and selecting the first RAT to use by reading the RAT selecting information when the mobile device powers on.

A communication device of a wireless communication system for RAT selection is disclosed. The communication device includes means for selecting a first RAT to use when powering on, wherein the first RAT is capable of providing services of a first service domain, means for handing over to a second RAT capable of providing services of a second service domain when the communication device needs to perform a first service on the second service domain, and means for returning to the first RAT when the communication device needs to perform a second service on the first service domain.

A communication device of a wireless communication system for RAT selection for a communication device in a wireless communication system is disclosed. The communication device includes means for storing RAT selecting information corresponding to a first RAT, wherein the first RAT is used by the communication device upon the powering-off, and means for selecting the first RAT to use by reading the RAT selecting information when the communication device powers on.

These and other objectives of the present disclosure will no doubt become obvious to those of ordinary skill in the art after reading the following detailed description of the preferred example that is illustrated in the various figures and drawings.

### BRIEF DESCRIPTION OF THE DRAWINGS

FIG. 1 is a schematic diagram of an examplary wireless communications system.

FIG. 2 is a schematic diagram of an examplary communication device.

FIG. 3 is a flowchart of an examplary process.

FIG. 4 is a flowchart of an examplary state diagram of the mobile device according to FIG. 3.

FIG. 5 is a flowchart of an examplary state diagram of the mobile device according to FIG. 3.

FIG. 6 is a flowchart of an examplary process.

FIG. 7 is a flowchart of an examplary state diagram of the mobile device according to FIG. 6.

### DETAILED DESCRIPTION

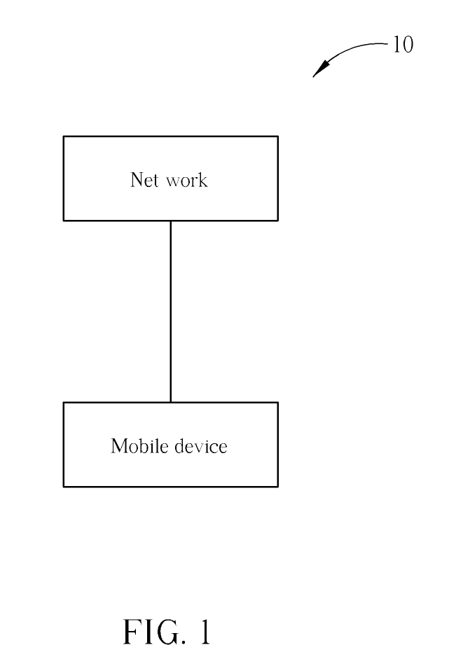

Please refer to FIG. 1, which illustrates a schematic diagram of an exemplary wireless communication system 10, in which a mobile device can select different radio access technologies (RATs) to use. For example, when the mobile device selects a long term evolution (LTE) RAT to use, the mobile device selects a cell of an evolved universal terrestrial radio access network (E-UTRAN) to camp on. When the mobile device selects a universal mobile telecommunications system (UMTS) RAT to use, the mobile device selects a cell of a universal terrestrial radio access network (UTRAN) to camp on. When the mobile device selects a global system for mobile communications (GSM) RAT to use, the mobile device selects a cell of a GSM EDGE Radio Access Network (GERAN) to camp on. The E-UTRAN/UTRAN/GERAN is the network illustrated in FIG. 1. the mobile devices are referred as to user equipments (UEs)/mobile stations (MSs) that can be devices such as mobile phones, computer systems, etc. This terminology will be used throughout the application for ease of reference, however, this should not be construed as limiting the disclosure to any one particular type of network. The cell of the E-UTRAN/UTRAN/GERAN is hereinafter called LTE/3G(third generation)/2G(second generation) cell, respectively.

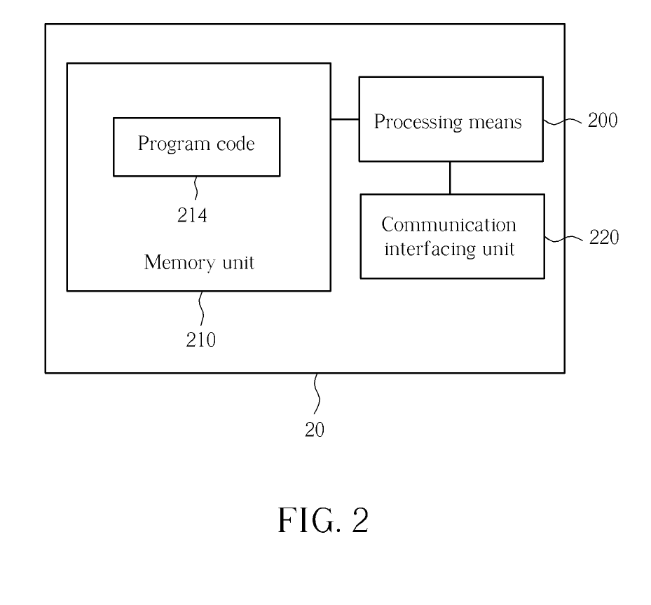

Please refer to FIG. 2, which illustrates a schematic diagram of an examplary communication device 20. The communication device 20 may be a mobile device of FIG. 1 and include a process means 200 such as a microprocessor or ASIC (Application-Specific Integrated Circuit), a memory unit 210 and a communication interfacing unit 220. The memory unit 210 may be any data storage device that can store program code 214 for access by the process means 200. Examples of the memory unit 210 include but are not limited to a subscriber identity module (SIM), read-only memory (ROM), random-access memory (RAM), CD-ROMs, magnetic tapes, hard disks, and optical data storage devices. The communication interfacing unit 220 may be preferably a radio transceiver and accordingly exchanges wireless signals with other communication devices according to processing results of the process means 200.

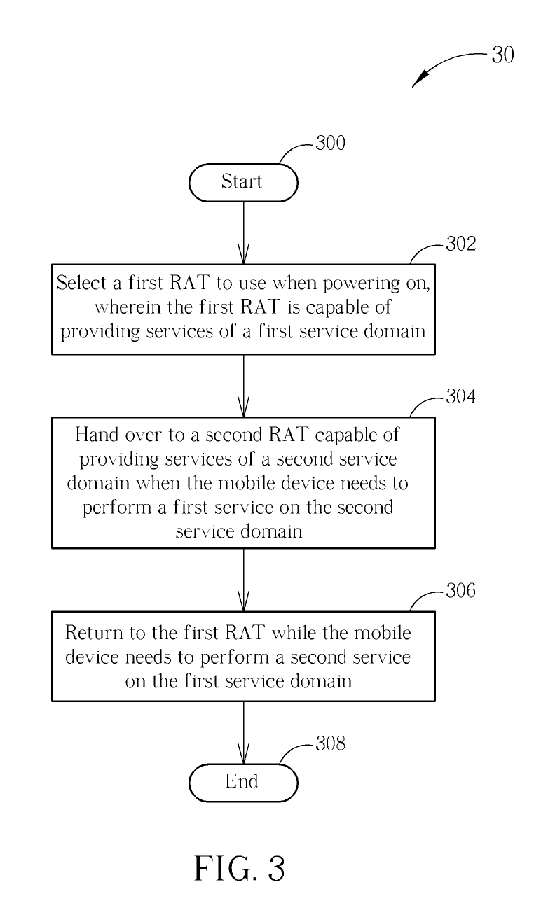

Please refer to FIG. 3, which is a flowchart of an examplary process 30 that is provided for RAT selection for a mobile device in a wireless communications system. The process 30 may be compiled into the program code 214 and includes the following steps:

Step 300: Start.

Step 302: Select a first RAT to use when powering on, wherein the first RAT is capable of providing services of a first service domain.

Step 304: Hand over to a second RAT capable of providing services of a second service domain when the mobile device needs to perform a first service on the second service domain.

Step 306: Return to the first RAT while the mobile device needs to perform a second service on the first service domain.

Step 308: End.

According to the process 30, the first RAT is the first preference to use for the mobile device when powering on. This may mean that the mobile device select a cell of the first RAT to camp on. A network of the first RAT may initiate the first service and thereby request the mobile device to perform the first service that can be established on the second service domain but not the first service domain. Or, the mobile device may autonomously initiate the first service. In these situations, the mobile device hands over to the second RAT. This may mean that the mobile device select a cell of the second RAT to camp on. The mobile device may not immediately return to the first RAT when the first service is finished. Instead, the mobile device may return to the first RAT at the time the mobile device needs to perform a second service on the first service domain. Similarly, the second service may be initiated by the network or the mobile device. As can be seen from the above, the mobile device does not immediately return to the first RAT while the first service is finished. The mobile device changes its RAT when a service that cannot be performed on the currently-used RAT is initiated. Thus, the number of RAT switching can be reduced, thereby avoiding a delay in service establishment.

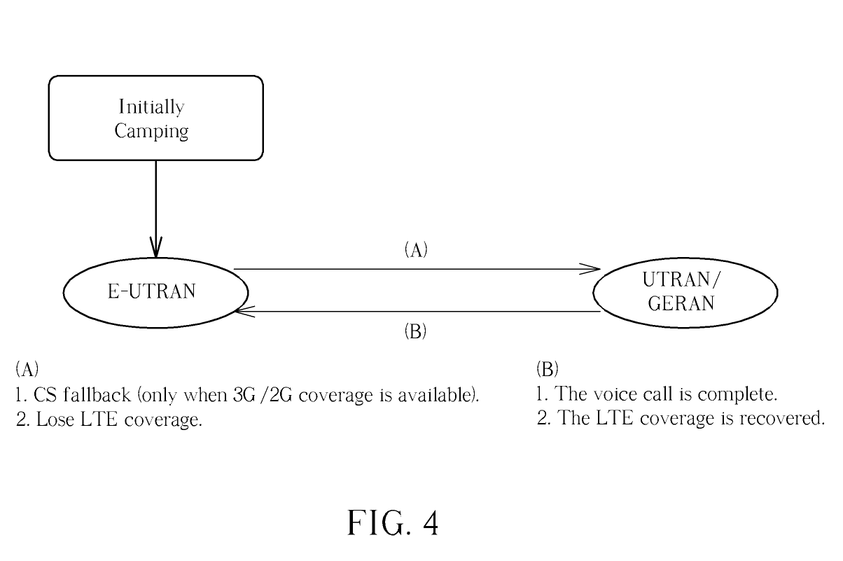

Please refer to FIG. 4, which is a state diagram of a mobile device in a LTE preferred mode, made based on the concept of the process 30. In FIG. 4, the mobile device in the LTE preferred mode initially camps on a LTE cell (the cell of E-UTRAN) when powering on. That is, the mobile device sets LTE cell to higher priority as compared to the 3G/2G cells in RAT selection configuration. The LTE system is known supporting a packet switched (PS) domain and not supporting a circuited switched (CS) domain. The PS and CS domains are two types of service domains. The mobile device may enter a radio resource control (RRC) connected state to initiate a data service, e.g. web browsing, file transferring on a filing transfer protocol (FTP), video conferencing, tethering or any streaming service needed to be performed only on the PS domain. A service that can be performed on the PS domain but not on the CS domain is known as PS service. A service that can be performed on the CS domain but not on the PS domain is known as CS service. A mobile originating (MO) or mobile terminated (MT) voice call, known as CS service, maybe triggered when the mobile device in the “E-UTRAN” state illustrated in FIG. 4. Since the MO/MT call needs to be performed on the CS domain and the E-UTRAN does not support any CS service, the mobile device performs a CS fallback procedure that is a handover procedure allowing the UE to hand over to a network/RAT supporting CS service. Detailed operation of the CS fallback procedure is well-known in the art. In FIG. 4, the mobile device hands over to “UTRAN/GERAN” state, i.e. the mobile device moves out of the LTE cell and then selects a 3G/2G cell to camp on. After the CS fallback handover is finished, the mobile device makes the MO/MT voice call in the UTRAN/GERAN. After the voice call is completed, the mobile device returns to the LTE RAT.

In FIG. 4, the following events trigger the mobile device to move from the “E-UTRAN” to “UTRAN/GERAN” state:

(i) the CS service is initiated and the CS fallback procedure is needed (only when 3G/2G coverage is available, e.g. a 3G/2G cell can be found during cell search).
(ii) the mobile device loses the LTE coverage, e.g. the mobile device cannot receive LTE signals for a period of time.

In addition, the following events trigger the mobile device to move from the “UTRAN/GERAN” to “E-UTRAN” state:

(i) a data session of a PS service is initiated.
(ii) the mobile device loses the LTE coverage, e.g. when the mobile device cannot receive LTE signals for a period of time.
(iii) the LTE coverage is recovered, e.g. the mobile device can receive the LTE signals within certain period of time after losing the LTE coverage.

Please note that the mobile device may initially camp on the 3G/2G cell due to the loss of LTE coverage. In this situation, CS and PS services both can be provided under the UTRAN/GERAN network.

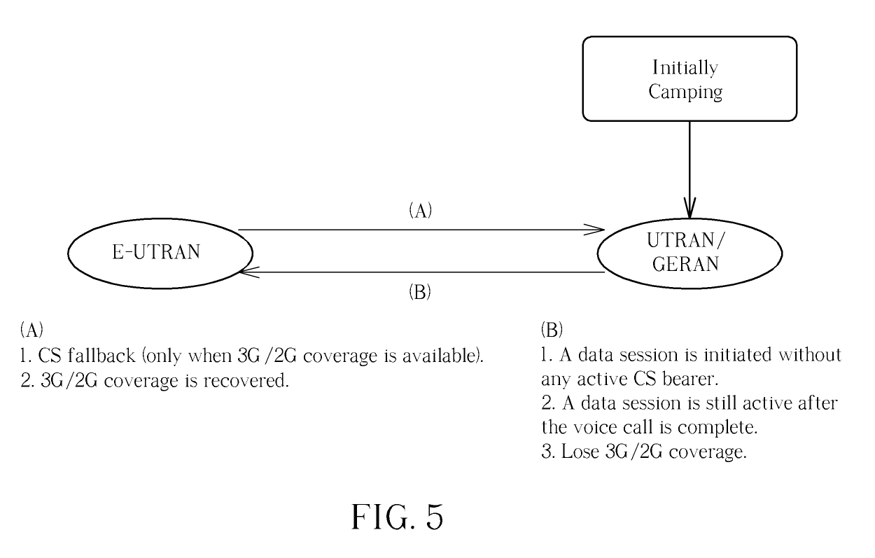

Please refer to FIG. 5, which is a state diagram of a mobile device in a legacy preferred mode, made based on the concept of the process 30. In FIG. 5, the mobile device in the legacy preferred mode initially camps on a 3G/2G cell (the cell of UTRAN/GERAN) when powering on. That is, the mobile device sets 3G/2G cell to higher priority as compared to the LTE cells in RAT selection configuration. The 3G/2G system is known supporting both the PS and CS domains. When a data service, e.g. web browsing, file transferring on a filing transfer protocol (FTP), video conferencing, tethering or any streaming service is initiated, the mobile device hands over to a LTE cell, designed for providing better data transfer efficiency than the 3G/2G cell, to start the data PS service, i.e. the mobile device hands over to “E-UTRAN” state. Then if a MO or MT voice call is triggered, the mobile device performs the CS fallback procedure to make the voice call in the “UTRAN/GERAN” state. The voice call and the data PS service can be performed in parallel. After the voice call is completed, the mobile device may return to the LTE RAT if the data PS service may not have been terminated yet. Or, after the voice call is completed, the mobile device may stay in the “UTRAN/GERAN” state if the data PS service has already been terminated.

In FIG. 5, the following events trigger the mobile device to move from the “UTRAN/GERAN” to “E-UTRAN” state:

(i) a data service is initiated without any active CS bearer (i.e. a PS service), wherein a CS bearer is used for transferring CS data.
(ii) a data service (PS service) is still active/on-going after a voice call is complete.
(iii) the mobile device loses the 3G/2G coverage, e.g. when the mobile device cannot receive 3G/2G signals from the UTRAN/GERAN for a period of time.

In addition, the following events trigger the mobile device to move from the “E-UTRAN” to “UTRAN/GERAN” state:

(i) the CS fallback procedure is needed (only when the 3G/2G coverage is available, e.g. a 3G/2G cell can be found during cell search).
(ii) the 3G/2G coverage is recovered, e.g. the mobile device can receive the 3G/2G signals within certain period of time after losing the 3G/2G coverage.

Please note that the mobile device may initially camps on a LTE cell due to the loss of 3G/2G coverage. All data PS services will be provided over the LTE network, and there is no CS voice service available in this situation. The UE may further move to the UTRAN/GERAN after the 3G/2G coverage has been recovered.

Thus, the above examples allow the mobile device not to return to the LTE cell until a PS service is initiated after a CS service is complete. Also, the examples allow the mobile device not to return to the 3G/2G cell until a CS service is initiated after a PS service is complete.

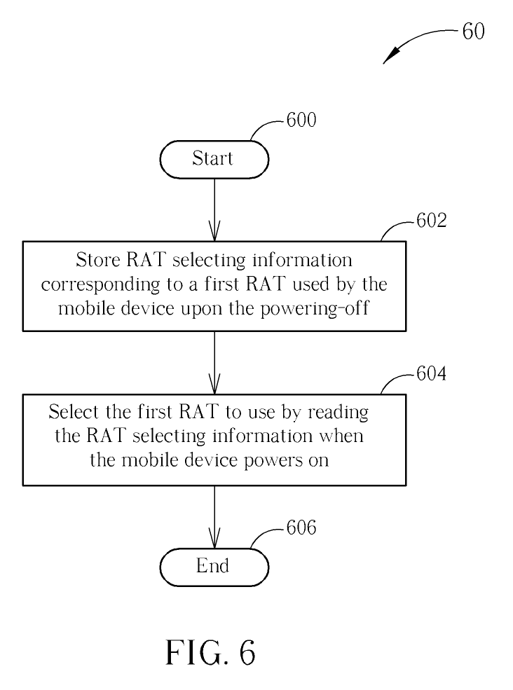

Please refer to FIG. 6, which is a flowchart of an examplary process 60 that is provided for RAT selection for a mobile device in a wireless communications system. The process 60 may be compiled into the program code 214 and includes the following steps:

Step 600: Start.

Step 602: Store RAT selecting information corresponding to a first RAT used by the mobile device upon the powering-off.

Step 604: Select the first RAT to use by reading the RAT selecting information when the mobile device powers on.

Step 606: End.

According to the process 60, the mobile device performs a powering-off procedure when the first RAT is in-use. In this situation, the mobile device stores the RAT selecting information indicating that the last used RAT before the powering-off is the first RAT. When the mobile device powers on, the RAT selecting information is read, and thereby the mobile device selects the first RAT to use. In other words, the mobile device initially camps on a cell of the first RAT when powering on since the RAT selecting information indicates the first RAT.

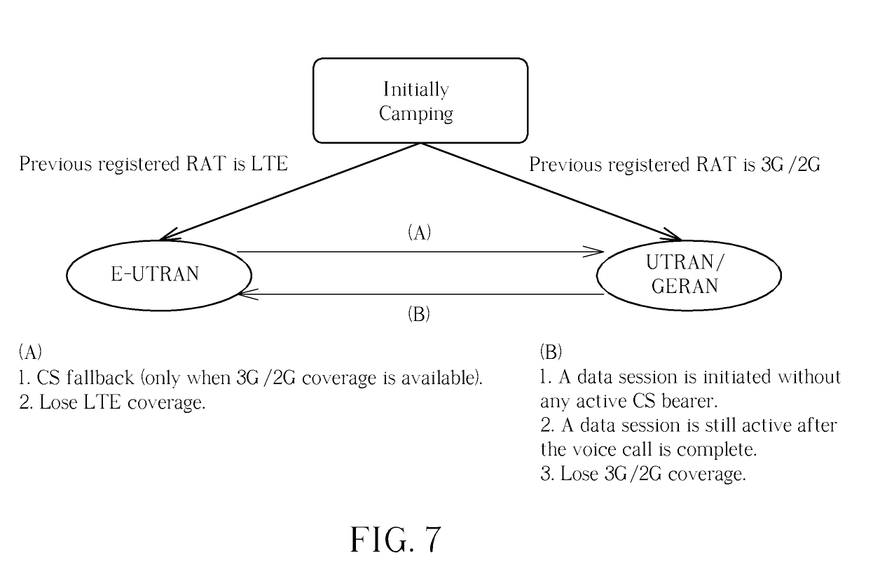

Please refer to FIG. 7, which is a state diagram of a mobile device in a hybrid LTE and legacy mode, made based on the concept of the process 60. The mobile device in the hybrid LTE and legacy mode initially camps on a LTE or 3G/2G cell based on the previously-registered RAT. The configuration information about the RAT of the previously-camped cell (e.g. the RAT selecting information) is stored in the memory (e.g. the memory unit 210) as the previously-registered RAT before the mobile device powers off. Then when the mobile device powers on, the mobile device prefers to camp on the cell with the same RAT as the previously-registered RAT.

If the mobile device initially camps on a LTE cell (i.e. in the E-UTRAN state), the CS fallback procedure may be triggered when the mobile device intends to make a MO or MT voice call. After the voice call has been finished, the mobile device stays in the UTRAN/GERAN (i.e. in the 3G/2G state) until a data PS service is initiated, e.g. browsing or tethering. The mobile device may move to the LTE cell only when the data PS service is initiated.

If the mobile device initially camps on a 3G/2G cell, the mobile device moves to the LTE RAT when a data PS service is initiated, e.g. browsing or tethering. The mobile device may perform the CS fallback procedure during a PS data session of the data PS service when a MO or MT voice call is triggered. If the PS data session is terminated during the voice call, the mobile device may stay in the UTRAN/GERAN until the next data service is initiated. If the data session is not terminated after the voice call has been completed, the UE moves to the LTE RAT. The after the data session is terminated in the LTE RAT, the mobile device may stay in the LTE network until another MO or MT voice call is triggered.

In FIG. 7, the following events trigger the mobile device to move from the “UTRAN/GERAN” to “E-UTRAN” state:

(i) a data service is initiated without any active CS bearer (i.e. a PS service), wherein a CS bearer is used for transferring CS data.
(ii) a data service (PS service) is still active/on-going after a voice call is complete.
(iii) the mobile device loses the 3G/2G coverage, e.g. when the mobile device cannot receive 3G/2G signals from the UTRAN/GERAN for a period of time.

In addition, the following events trigger the mobile device to move from the “E-UTRAN” to “UTRAN/GERAN” state:

(i) the CS fallback procedure is needed (only when the 3G/2G coverage is available, e.g. a 3G/2G cell can be found during cell search).
(ii) the mobile device loses the LTE coverage, e.g. the mobile device cannot receive LTE signals for a period of time.

The above example provides a way for the mobile device to select an initial RAT. In addition, the example allows the mobile device not to return to the LTE cell until a PS service is initiated after a CS service is complete. Also, the examples allow the mobile device not to return to the 3G/2G cell until a CS service is initiated after a PS service is complete.

Thus, the mobile device behavior of the hybrid LTE and legacy mode is defined to deal with the call setup delay and call setup failure introduced by the CS fallback procedure when the UE is in LTE preferred mode. The hybrid LTE and legacy mode can also deal with the degradation of user experiences due to the LTE transition delay when the UE is in the legacy preferred mode.

In conclusion, the present disclosure defines the UE behavior (behavior for a mobile device) of RAT selection when the CS fallback is applied as the LTE voice solution. The mobile device in the LTE preferred mode prefers to camps on a LTE cell. The mobile device returns to the UTRAN/GERAN only when a MT or MO voice call is triggered. The mobile device may move back to LTE RAT right after the voice call is completed. The mobile device in the legacy preferred mode prefers to camp on a 3G/2G cell; the mobile device moves to the LTE network only when certain data service is initiated and then moves back to UTRAN/GERAN right after the data session is terminated. The mobile device in the hybrid LTE and legacy mode camps on a cell based on the previously-registered RAT.

Those skilled in the art will readily observe that numerous modifications and alterations of the device and method may be made while retaining the teachings of the disclosure. Accordingly, the above disclosure should be construed as limited only by the metes and bounds of the appended claims.

What is claimed is:

1. A method of radio access technology (RAT) selection for a mobile device in a wireless communication system, the method comprising:
selecting a first RAT to use when powering on, wherein the first RAT is capable of providing services of a first service domain;
handing over to a second RAT capable of providing services of a second service domain when the mobile device needs to perform a first service on the second service domain; and
returning to the first RAT while the mobile device needs to perform a second service on the first service domain.

2. The method of claim 1 further comprising:
not immediately returning to the first RAT when the first service is finished.

3. The method of claim 1, wherein the first RAT is not capable of providing the services of the second service domain.

4. A method of radio access technology (RAT) selection for a mobile device in a wireless communication system, the method comprising:
storing RAT selecting information corresponding to a first RAT, wherein the first RAT is used by the mobile device upon the powering-off; and
selecting the first RAT to use by reading the RAT selecting information when the mobile device powers on.

5. The method of claim 4, wherein the first RAT is capable of providing services of a first service domain.

6. The method of claim 5 further comprising:
handing over to a second RAT capable of providing services of a second service domain when the mobile device needs to perform a first service on the second service domain; and
returning to the first RAT when the mobile device needs to perform a second service on the first service domain.

7. The method of claim 6 further comprising:
returning to the first RAT when the first service is finished.

8. A communication device of a wireless communication system for radio access technology (RAT) selection, the communication device comprising:
means for selecting a first RAT to use when powering on, wherein the first RAT is capable of providing services of a first service domain;
means for handing over to a second RAT capable of providing services of a second service domain when the communication device needs to perform a first service on the second service domain; and
means for returning to the first RAT when the communication device needs to perform a second service on the first service domain.

9. The communication device of claim 8 further comprising:
means for not immediately returning to the first RAT when the first service is finished.

10. The communication device of claim 8, wherein the first RAT is not capable of providing the services of the second service domain.

11. A communication device of a wireless communication system for radio access technology (RAT) selection for a communication device in a wireless communication system, the communication device comprising:
means for storing RAT selecting information corresponding to a first RAT, wherein the first RAT is used by the communication device upon the powering-off; and
means for selecting the first RAT to use by reading the RAT selecting information when the communication device powers on.

12. The communication device of claim 11, wherein the first RAT is capable of providing services of a first service domain.

13. The communication device of claim 12 further comprising:
handing over to a second RAT capable of providing services of a second service domain when the communication device needs to perform a first service on the second service domain; and
returning to the first RAT when the communication device needs to perform a second service on the first service domain.

14. The communication device of claim 13 further comprising:
returning to the first RAT when the first service is finished.
